(19) United States
(12) Patent Application Publication
(10) Pub. No.: US 2011/0192896 A1
(43) Pub. Date: Aug. 11, 2011

(54) ELECTRONIC NAME CARD AND ELECTRONIC NAME CARD SYSTEM USING RADIO FREQUENCY OR MICROWAVE IDENTIFICATION

(75) Inventor: YEN-SHIH HO, Kaohsiung (TW)

(73) Assignee: PAUYI TECHNOLOGY CO., LTD., Kaohsiung City (TW)

(21) Appl. No.: 12/703,064

(22) Filed: Feb. 9, 2010

(51) Int. Cl. G06F 17/00; G06K 19/067; G06K 7/00

(52) U.S. Cl. 235/380; 235/487

(57) ABSTRACT

An electronic name card and an electronic name card system using radio frequency or microwave identification are disclosed. A chip in the electronic name card includes an identification code and a reserved memory block, and the identification code is used to store an identification data thereof, and the reserved memory block is used to store a user's information thereof. Therefore, the memory section of the chip can be used efficiently to achieve the identification function of the electronic name card. By using the electronic name card system, the user can utilize a reading device to read and store the information in an electronic form without scanning or transforming, and the manual input and amendment are not needed to achieve the electronic management for the name card.

### FIELD OF THE INVENTION

The present invention relates to an electronic name card, and more particularly, to an electronic name card and an electronic name card system using radio frequency or microwave identification, such that the size of the electronic name card is similar to a paper name card.

### BACKGROUND OF THE INVENTION

Currently, radio frequency identification (RFID) cards are applicable to be labels or identifying codes used for products or by workers, or for an entrance guard system to identify people, objects or equipments. Therefore, the identifying codes of RFID cards are merely used, and the other memory space thereof is not used.

In general, name cards are made of paper for showing a user's information, such as user's name or company name. For an electronic way of managing name cards, a scanner is used to scan the information of the name cards and transform it into an electronic data for reading. However, types of the name cards are numerous and inconsistent, resulting in difficulties of scanning and reading the information of the name cards. Therefore, the data transformed from the name cards is often different to the original information thereof, and thus needs to be modified manually. As a result, the electronic managing of name cards can be not achieved completely.

Therefore, it is desirable to provide an electronic name card and a system for the same using radio frequency or microwave identification and with novelty and advancement so as to resolve above-mentioned problems.

### SUMMARY OF THE INVENTION

Therefore, an aspect of the present invention is to provide an electronic name card and an electronic name card system using radio frequency or microwave identification for using the memory section of a chip of the electronic name card efficiently.

According to one embodiment of the present invention, the electronic name card using radio frequency or microwave identification comprises a substrate, an antenna and a chip. The antenna is disposed on the substrate and configured to transmit and receive data. The chip disposed on the substrate and connected to the antenna, wherein the chip includes an identification code and a reserved memory block, and the identification code is configured to store an identification data of the electronic name card, and the reserved memory block is configured to store a user's information.

According to another embodiment of the present invention, the electronic name card system using radio frequency or microwave identification comprises at least one electronic name card and a reading device. The electronic name card comprises a substrate, a first antenna and a chip, wherein the first antenna is disposed on the substrate and configured to transmit and receive data, and the chip is disposed on the substrate and connected to the first antenna, and the chip includes an identification code and a reserved memory block, and the identification code is configured to store an identification data of the electronic name card, and the reserved memory block is configured to store a user's information. The reading device includes a second antenna and a controller, wherein the second antenna is configured to transmit and receive data, and the controller is connected to the second antenna and configured to control the second antenna to transmit signal to the first antenna, thereby activating the chip, and the identification data and the user's information of the chip are transmitted by the first antenna and the second antenna, and read by the controller.

Therefore, with the use of the electronic name card system disclosed in the present invention, the reserved memory block is used to store the user's information of the electronic name card, thereby using the memory section of the chip efficiently to achieve the identification function. By using the electronic name card system of the present invention, when receiving the electronic name card, the reading device is utilized to read and store the data of the electronic name card without any scanning or transforming, and the manual input and amendment are not needed to achieve the electronic management for name cards.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is a schematic diagram showing an electronic name card using radio frequency or microwave identification according to the present invention;

FIG. 1B is a schematic diagram showing an electronic name card using radio frequency according to the present invention;

FIG. 1C is a schematic diagram showing an electronic name card using microwave identification according to the present invention;

FIG. 2 is a schematic diagram showing an electronic name card system using radio frequency or microwave identification according to the present invention;

FIG. 3 is a schematic diagram showing an identification code and a reserved memory block according to the present invention; and

FIG. 4 is a schematic diagram showing a controller according to the present invention.

### DETAILED DESCRIPTION OF THE PREFERRED EMBODIMENT

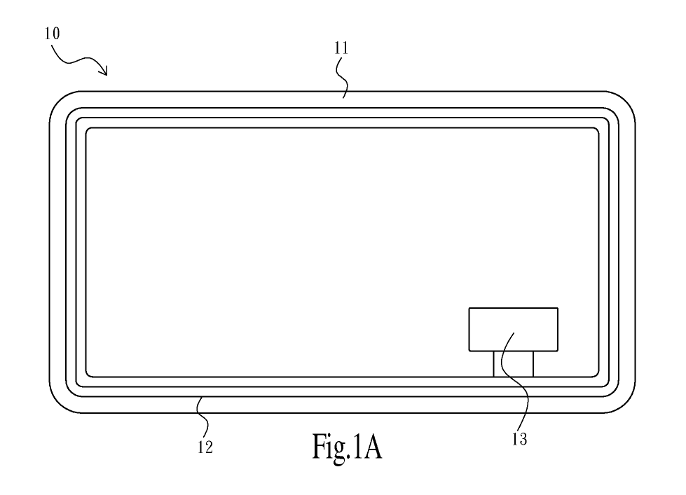

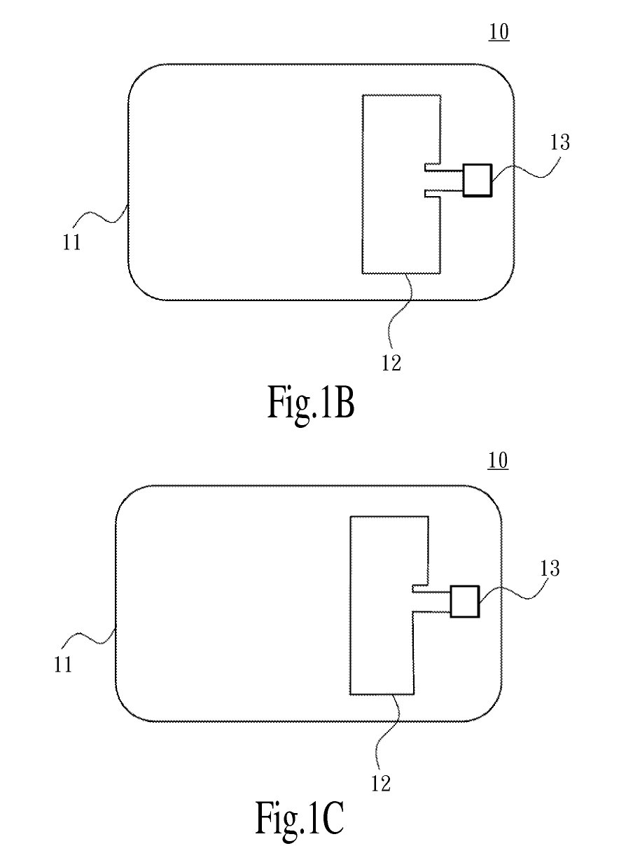

In order to make the illustration of the present invention more explicit and complete, the following description is stated with reference to FIG. 1A through FIG. 4.

Referring to FIG. 1A through FIG. 1C, presented herein are schematic diagrams showing an electronic name card using radio frequency or microwave identification according to the present invention. The electronic name card 10 using radio frequency (referring to FIG. 1B) or microwave identification (referring to FIG. 1C) of the present invention comprises a substrate 11, an antenna 12 and a chip 13. The antenna 12 is disposed on the substrate 11 and configured to transmit and receive data. The chip 13 is disposed on the substrate 11 and electrically connected to the antenna 12.

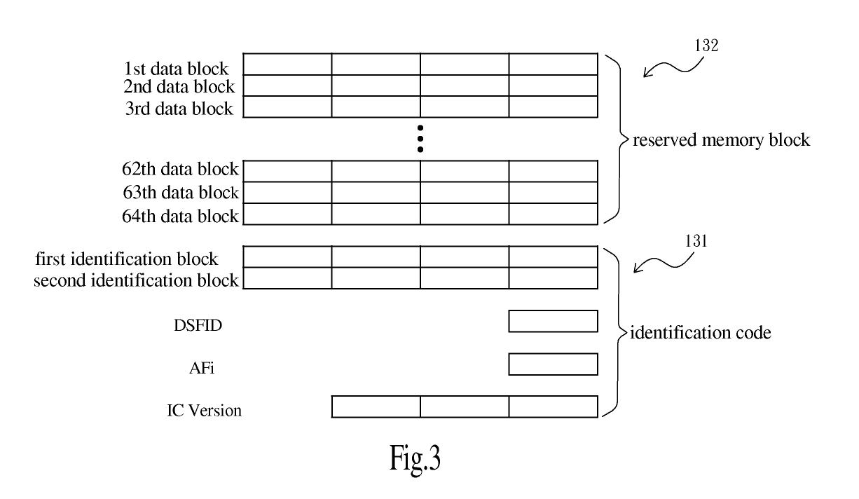

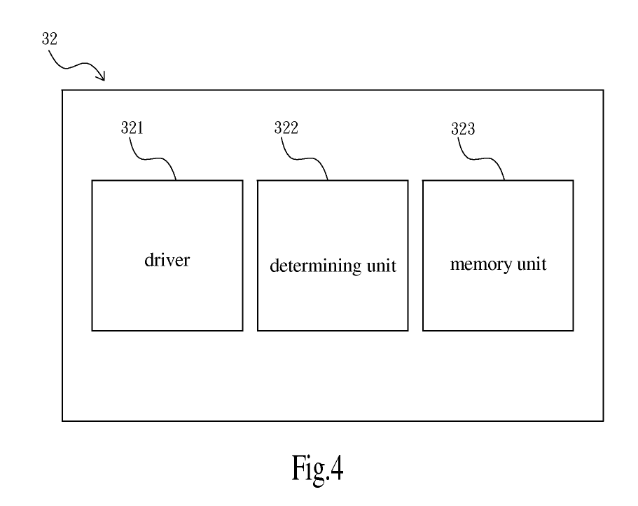

Referring to FIG. 3, the chip 13 includes an identification code 131 and a reserved memory block 132, wherein the identification code 131 is configured to store an identification data of the electronic name card, and the reserved memory block 132 is configured to store a user's information of the electronic name card. The identification code 131 includes a first identification block and a second identification block for storing the identification data. The identification code 131 may further include maker's identification data, such as DSFID, AFi and IC version.

The reserved memory block 132 includes a plurality of data blocks configured to store the user's information. In the present embodiment, the reserved memory block 132 includes 64 data blocks, and each of the data blocks is 4 bytes. The data stored in the reserved memory block 132 of the present embodiment may include the user's name of 32 bytes, the user's company name of 32 bytes, the user's company address of 84 bytes, a first phone number of the user's company of 16 bytes, a second phone number of the user's company of 16 bytes, the user's electronic mail address of 32 bytes, a fax number of the user's company of 16 bytes and the user's other information of 16 bytes. However, the reserved memory block of the present invention may comprise other memory spaces and designs for storing the user's information but not limited to the above description.

Since a reserved memory block of a conventional RFID card is locked in manufacturing, it can not be used. The electronic name card of the present invention can use the reserved memory block 132 to store the user's information, and thus an existing RFID card can be utilized. Therefore, there is no need to redesign the chip of the electronic name card, and the memory section of the chip can be used efficiently to achieve the identification function of the electronic name card.

Furthermore, the thickness of a conventional RFID card or a microwave identification card is too thick for being the electronic name card. Therefore, the thickness of the chip 13 of the electronic name card on the present invention is preferably less than 50 μm, thereby making the thickness of the electronic name card is preferably less than 200 μm for transporting and saving space.

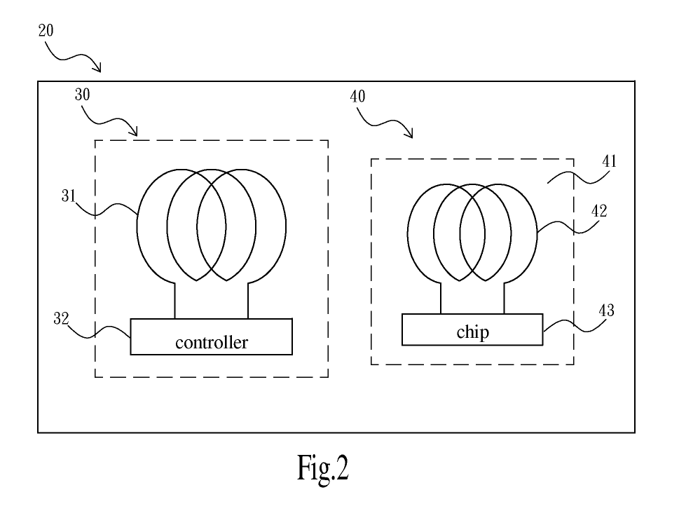

Referring to FIG. 2, presented herein is a schematic diagram showing an electronic name card system using radio frequency or microwave identification according to the present invention. The electronic name card system 20 using radio frequency or microwave identification of the present invention comprises at least one electronic name card 40 and a reading device 30. Each electronic name card 40 comprises a substrate 41, a first antenna 42 and a chip 43. The first antenna 42 is disposed on the substrate 41 and configured to transmit and receive data. The chip 43 is disposed on the substrate 41 and electrically connected to the first antenna 42. The chip 43 includes an identification code and a reserved memory block wherein the identification code is configured to store an identification data of the electronic name card 40, and the reserved memory block is configured to store the user's information thereof. The user's information belongs to a user of the electronic name card. The electronic name card 40 is similar to the above-mentioned electronic name card 10, and thus is not stated in detail herein.

The reading device 30 includes a second antenna 31 and a controller 32. The second antenna 31 is configured to transmit and receive data. The controller 32 is electrically connected to the second antenna 31 for controlling it to transmit signal to the first antenna 42, thereby activating the chip 43. The identification data and the user's information of the chip 43 can be transmitted by the first antenna 42 and the second antenna 31, and read by the controller 32.

Referring to FIG. 4, presented herein is a schematic diagram showing the controller according to the present invention. The controller 32 includes a driver 321, a determining unit 322 and a memory unit 323, wherein the driver 321 is configured to transmit at least one driving signal to the chip 43 through the first antenna 42 and the second antenna 31. In the present embodiment, the driver 321 is configured to transmit a first driving signal and at least one second driving signal. The first driving signal is transmitted to the chip 43 through the first antenna 42 and the second antenna 31 for making the chip 43 to transmit the identification data of the electronic name card 40 to the determining unit 322 of the controller 32 through the first antenna 42 and the second antenna 31.

The determining unit 322 is configured to receive the identification data of the electronic name card 40 and identify it. If the identification data is identified and received, the user's information of the electronic name card 40 is then received. Therefore, the driver 321 transmits the second driving signal to the chip 43 through the first antenna 42 and the second antenna 31, thereby making the chip 43 to transmit the user's information of the electronic name card 40 to the memory unit 323 of the controller 32 through the first antenna 42 and the second antenna 31. The memory unit 323 is configured to store the user's information of the electronic name card 40. If the user's information is too large, the driver 321 can transmit a plurality of second driving signals to the chip 43, thereby making the chip 43 to transmit the user's information in a plurality of times.

Therefore, with the use of the electronic name card system of the present invention, when receiving the electronic name card, the reading device is utilized to read and store the data of the electronic name card without any scanning or transforming, and the manual input and amendment are not needed to achieve the electronic management for name card.

As is understood by a person skilled in the art, the foregoing embodiments of the present invention are strengths of the present invention rather than limiting of the present invention. It is intended to cover various modifications and similar arrangements included within the spirit and scope of the appended claims, the scope of which should be accorded the broadest interpretation so as to encompass all such modifications and similar structures.

What is claimed is:

1. An electronic name card using radio frequency or microwave identification, comprising:
a substrate;
an antenna disposed on the substrate and configured to transmit and receive data; and
a chip disposed on the substrate and connected to the antenna, wherein the chip includes an identification code and a reserved memory block, and the identification code is configured to store an identification data of the electronic name card, and the reserved memory block is configured to store a user's information of the electronic name card.

2. The electronic name card of claim 1, wherein the identification code includes a first identification block and a second identification block configured to store the identification data.

3. The electronic name card of claim 1, wherein the reserved memory block includes a plurality of data blocks configured to store the user's information.

4. The electronic name card of claim 3, wherein the reserved memory block includes 64 data blocks, and each of the data blocks is 4 bytes.

5. The electronic name card of claim 4, wherein the data stored in the reserved memory block include the user's name of 32 bytes, the user's company name of 32 bytes, the user's company address of 84 bytes, a first phone number of the user's company of 16 bytes, a second phone number of the user's company of 16 bytes, the user's electronic mail address of 32 bytes, a fax number of the user's company of 16 bytes and the user's other information of 16 bytes.

6. The electronic name card of claim 1, wherein the thickness of the chip is less than 50 μm, and the thickness of the electronic name card is less than 200 μm.

7. An electronic name card system using radio frequency or microwave identification, comprising:
at least one electronic name card comprising a substrate, a first antenna and a chip, wherein the first antenna is disposed on the substrate and configured to transmit and receive data, and the chip is disposed on the substrate and connected to the first antenna, and the chip includes an identification code and a reserved memory block, and the identification code is configured to store an identification data of the electronic name card, and the reserved memory block is configured to store a user's information of the electronic name card; and
a reading device including a second antenna and a controller, wherein the second antenna is configured to transmit and receive data, and the controller is connected to the second antenna and configured to control the second antenna to transmit signal to the first antenna, thereby activating the chip, and the identification data and the user's information of the chip are transmitted by the first antenna and the second antenna, and read by the controller.

8. The electronic name card system of claim 7, wherein the identification code includes a first identification block and a second identification block configured to store the identification data.

9. The electronic name card system of claim 7, wherein the reserved memory block includes a plurality of data blocks configured to store the user's information.

10. The electronic name card system of claim 9, wherein the reserved memory block includes 64 data blocks, and each of the data blocks is 4 bytes.

11. The electronic name card system of claim 10, wherein the data stored in the reserved memory block include the user's name of 32 bytes, the user's company name of 32 bytes, the user's company address of 84 bytes, a first phone number of the user's company of 16 bytes, a second phone number of the user's company of 16 bytes, the user's electronic mail address of 32 bytes, a fax number of the user's company of 16 bytes and the user's other information of 16 bytes.

12. The electronic name card system of claim 7, wherein the thickness of the chip is less than 50 μm, and the thickness of the electronic name card is less than 200 μm.

13. The electronic name card system of claim 7, wherein the controller includes a driver, a determining unit and a memory unit, wherein the driver is configured to transmit at least one driving signal to the chip through the first antenna and the second antenna, and the determining unit is configured to receive and identify the identification data, and the memory unit is configured to store the user's information of the electronic name card.

14. The electronic name card system of claim 13, wherein the driver is configured to transmit a first driving signal and at least one second driving signal, the first driving signal is transmitted to the chip through the first antenna and the second antenna for making the chip to transmit the identification data of the electronic name card, and the second driving signal is transmitted to the chip through the first antenna and the second antenna for making the chip to transmit the user's information of the electronic name card.
